(19) United States
(12) Patent Application Publication
(10) Pub. No.: US 2025/0168903 A1
(43) Pub. Date: May 22, 2025

(54) UNCREWED AERIAL SYSTEM SERVICE SUPPLIER UNCREWED AERIAL VEHICLE AUTHORIZATION AND AUTHENTICATION EVENT SUBSCRIPTION

(71) Applicant: Lenovo (Singapore) Pte. Ltd., New Tech Park (SG)

(72) Inventors: Roozbeh Atarius, La Jolla, CA (US); Sheeba Backia Mary Baskaran, Friedrichsdorf (DE); Dimitrios Karampatsis, Ruislip (GB)

(21) Appl. No.: 18/838,983

(22) PCT Filed: Mar. 23, 2022
(86) PCT No.: PCT/EP2022/057709

§ 371 Date: Aug. 15, 2024

(30) Foreign Application Priority Data
Feb. 17, 2022 (GR) 20220100148

(51) Int. Cl. H04W 76/10; H04L 5/00; H04W 12/06; H04W 76/20; H04W 84/06

(52) U.S. Cl. CPC H04W 76/10; H04L 5/0053; H04W 12/06; H04W 76/20; H04W 84/06

(57) ABSTRACT

Apparatuses, methods, and systems are disclosed for uncrewed aerial system service supplier uncrewed aerial vehicle authorization and authentication event subscription. One method includes receiving, by a second network entity from a first network entity, a request to establish or modify a protocol data unit (PDU) session. The first network entity received the request from a device. The method includes requesting, by the second network entity to the first network entity, an event subscription. The event subscription is associated with an event of an uncrewed aerial system (UAS) service supplier (USS) uncrewed aerial vehicle (UAV) authorization and authentication (UUAA) status of the device. The method includes receiving, at the second network entity, an event notification from the first network entity. The event notification includes: an acknowledgement of the event subscription; the UUAA status; or a combination thereof.

### FIELD

The subject matter disclosed herein relates generally to wireless communications and more particularly relates to uncrewed aerial system service supplier uncrewed aerial vehicle authorization and authentication event subscription.

### BACKGROUND

In certain wireless communications networks, UUAA may be performed. In such networks, a device may not know if the UUAA has been performed.

### BRIEF SUMMARY

Methods for uncrewed aerial system service supplier uncrewed aerial vehicle authorization and authentication event subscription are disclosed. Apparatuses and systems also perform the functions of the methods. One embodiment of a method includes receiving, by a second network entity from a first network entity, a request to establish or modify a protocol data unit (PDU) session. The first network entity received the request from a device. In some embodiments, the method includes requesting, by the second network entity to the first network entity, an event subscription. The event subscription is associated with an event of an uncrewed aerial system (UAS) service supplier (USS) uncrewed aerial vehicle (UAV) authorization and authentication (UUAA) status of the device. In certain embodiments, the method includes receiving, at the second network entity, an event notification from the first network entity. The event notification includes: an acknowledgement of the event subscription; the UUAA status; or a combination thereof.

One apparatus for uncrewed aerial system service supplier uncrewed aerial vehicle authorization and authentication event subscription includes a second network entity. In some embodiments, the apparatus includes a receiver that receives, by the second network entity from a first network entity, a request to establish or modify a protocol data unit (PDU) session. The first network entity received the request from a device. In various embodiments, the apparatus includes a transmitter that requests, by the second network entity to the first network entity, an event subscription. The event subscription is associated with an event of an uncrewed aerial system (UAS) service supplier (USS) uncrewed aerial vehicle (UAV) authorization and authentication (UUAA) status of the device. The receiver receives, at the second network entity, an event notification from the first network entity, and the event notification includes: an acknowledgement of the event subscription; the UUAA status; or a combination thereof.

Another embodiment of a method for uncrewed aerial system service supplier uncrewed aerial vehicle authorization and authentication event subscription includes receiving, by a first network entity from a device, an uplink (UL) non-access stratum (NAS) transport message including: a protocol data unit (PDU) session establishment request message; and an indicator indicating that the PDU session establishment request message is for establishing a PDU session for an uncrewed aerial system (UAS) service. In some embodiments, the method includes sending a notification from the first network entity to a second network entity indicating a UAS service supplier (USS) uncrewed aerial vehicle (UAV) authorization and authentication (UUAA) status of the device.

Another apparatus for uncrewed aerial system service supplier uncrewed aerial vehicle authorization and authentication event subscription includes a first network entity. In some embodiments, the apparatus includes a receiver that receives, by the first network entity from a device, an uplink (UL) non-access stratum (NAS) transport message including: a protocol data unit (PDU) session establishment request message; and an indicator indicating that the PDU session establishment request message is for establishing a PDU session for an uncrewed aerial system (UAS) service. In various embodiments, the apparatus includes a transmitter that sends a notification from the first network entity to a second network entity indicating a UAS service supplier (USS) uncrewed aerial vehicle (UAV) authorization and authentication (UUAA) status of the device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for uncrewed aerial system service supplier uncrewed aerial vehicle authorization and authentication event subscription;

FIG. 2 is a schematic block diagram illustrating one embodiment of an apparatus that may be used for uncrewed aerial system service supplier uncrewed aerial vehicle authorization and authentication event subscription;

FIG. 3 is a schematic block diagram illustrating one embodiment of an apparatus that may be used for uncrewed aerial system service supplier uncrewed aerial vehicle authorization and authentication event subscription;

FIG. 4 is a schematic block diagram illustrating one embodiment of a system for UUAA usage in a 5GS;

FIG. 5 is a schematic block diagram illustrating one embodiment of a system for performing UUAA at a time of UE registration;

FIG. 6 is a schematic block diagram illustrating one embodiment of a system for an AMF subscribing to a UE's UUAA status;

FIG. 7 is a schematic block diagram illustrating one embodiment of a system for an AMF informing an SMF about the UE's UUAA status;

FIG. 8 is a schematic block diagram illustrating one embodiment of a system for an SMF subscribing to the UE's UUAA status with a transmission towards an AMF;

FIG. 9 is a schematic block diagram illustrating one embodiment of a system for an SMF subscribing to the UE's UUAA status;

FIG. 10 is a flow chart diagram illustrating one embodiment of a method for uncrewed aerial system service supplier uncrewed aerial vehicle authorization and authentication event subscription; and

FIG. 11 is a flow chart diagram illustrating another embodiment of a method for uncrewed aerial system service supplier uncrewed aerial vehicle authorization and authentication event subscription.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

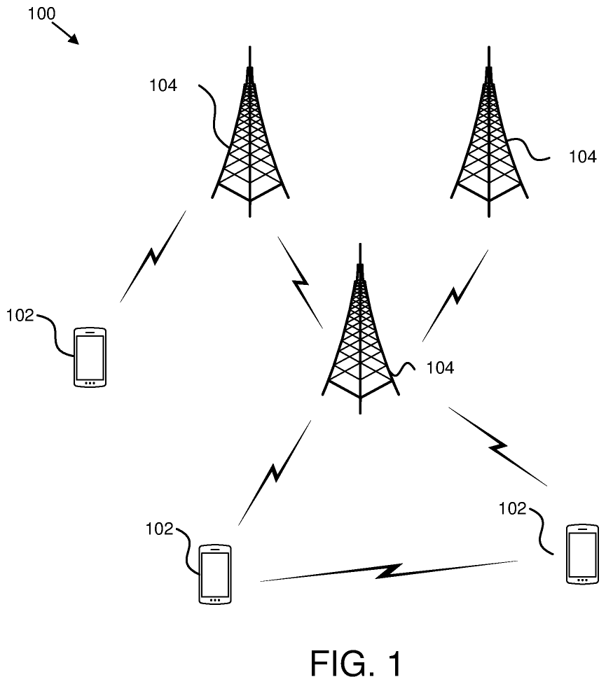

FIG. 1 depicts an embodiment of a wireless communication system 100 for uncrewed aerial system service supplier uncrewed aerial vehicle authorization and authentication event subscription. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, by a second network entity from a first network entity, a request to establish or modify a protocol data unit (PDU) session. The first network entity received the request from a device. In some embodiments, the network unit 104 may request, by the second network entity to the first network entity, an event subscription. The event subscription is associated with an event of an uncrewed aerial system (UAS) service supplier (USS) uncrewed aerial vehicle (UAV) authorization and authentication (UUAA) status of the device. In certain embodiments, the network unit 104 may receive, at the second network entity, an event notification from the first network entity. The event notification includes: an acknowledgement of the event subscription; the UUAA status; or a combination thereof. Accordingly, the network unit 104 may be used for uncrewed aerial system service supplier uncrewed aerial vehicle authorization and authentication event subscription.

In certain embodiments, a network unit 104 may receive, by a first network entity from a device, an uplink (UL) non-access stratum (NAS) transport message including: a protocol data unit (PDU) session establishment request message; and an indicator indicating that the PDU session establishment request message is for establishing a PDU session for an uncrewed aerial system (UAS) service. In some embodiments, the network unit 104 may send a notification from the first network entity to a second network entity indicating a UAS service supplier (USS) uncrewed aerial vehicle (UAV) authorization and authentication (UUAA) status of the device. Accordingly, the network unit 104 may be used for uncrewed aerial system service supplier uncrewed aerial vehicle authorization and authentication event subscription.

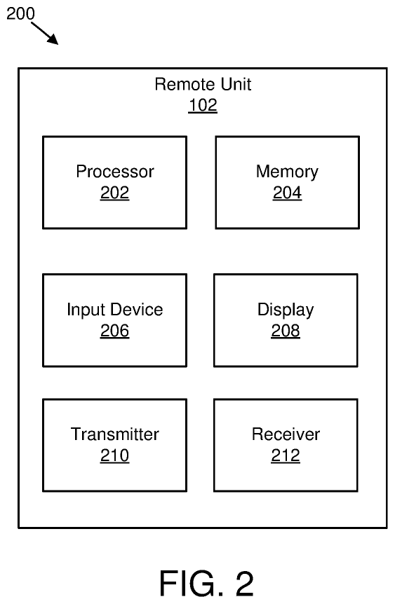

FIG. 2 depicts one embodiment of an apparatus 200 that may be used for uncrewed aerial system service supplier uncrewed aerial vehicle authorization and authentication event subscription. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

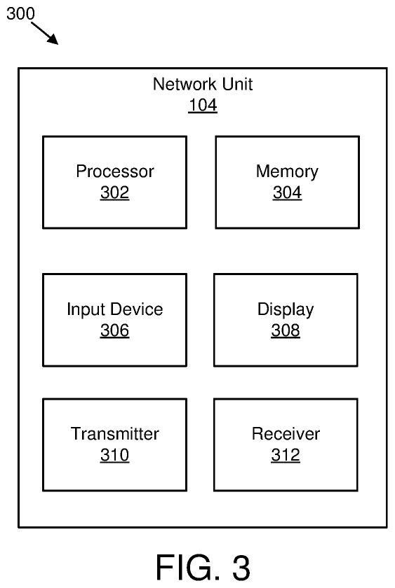

FIG. 3 depicts one embodiment of an apparatus 300 that may be used for uncrewed aerial system service supplier uncrewed aerial vehicle authorization and authentication event subscription. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives, by a second network entity from a first network entity, a request to establish or modify a protocol data unit (PDU) session. The first network entity received the request from a device. In various embodiments, the transmitter 310 requests, by the second network entity to the first network entity, an event subscription. The event subscription is associated with an event of an uncrewed aerial system (UAS) service supplier (USS) uncrewed aerial vehicle (UAV) authorization and authentication (UUAA) status of the device. The receiver 312 receives, at the second network entity, an event notification from the first network entity, and the event notification includes: an acknowledgement of the event subscription; the UUAA status; or a combination thereof.

In some embodiments, the receiver 312 receives, by a first network entity from a device, an uplink (UL) non-access stratum (NAS) transport message including: a protocol data unit (PDU) session establishment request message; and an indicator indicating that the PDU session establishment request message is for establishing a PDU session for an uncrewed aerial system (UAS) service. In various embodiments, the transmitter 310 sends a notification from the first network entity to a second network entity indicating a UAS service supplier (USS) uncrewed aerial vehicle (UAV) authorization and authentication (UUAA) status of the device.

In certain embodiments, a uncrewed aerial system (“UAS”) service supplier (“USS”) uncrewed aerial vehicle (“UAV”) authorization and/or authentication (“UUAA”) may be performed for a UAV during its registration to a fifth generation (“5G”) system or during a protocol data unit (“PDU”) session establishment and PDU session modification procedure related to a UAS service. If the UUAA is performed for a UAV during registration, then it may not be required to perform UUAA during a subsequent PDU session establishment procedure. In some embodiments, it may not be known how a session management function (“SMF”) involved in a PDU session establishment procedure will know whether or not a UUAA has been performed for the UAV.

In various embodiments, an SMF may invoke additional UUAA for the UAV during PDU session establishment procedure (e.g., without the knowledge of earlier successful UUAA) leading to a delayed UAS session set up and unnecessary overhead (e.g., inefficient resource utilization).

In some embodiments, 3GPP has architecture enhancements for UAVs with the following functionality: 1) authentication and authorization of a UAV with the USS during fifth generation system (“5GS”) registration; 2) authentication and authorization of a UAV with the USS during PDU session establishment and protocol data network (“PDN”) connection establishment; 3) support for USS authorization of command and control (“C2”) communication; and/or 4) a reference model for UAV tracking, supporting three UAV tracking modes: a) UAV location reporting mode; b) UAV presence monitoring mode; and c) unknown UAV tracking mode. In various embodiments, a 3GPP system supports geofencing (e.g., for in-flight UAV) and geocaging (e.g., for UAV on the ground intending to fly) functionality in USS by providing enablers (e.g., location services, event notification to a subscribing USS, and so forth). In certain embodiments, geofencing and/or geocaging mechanisms are an air traffic control functionality performed by the USS. Moreover, the 3GPP system provides enablers to support geofencing and/or geocaging functionality in USS (e.g., location services, enablement of C2 connectivity, event notification to a subscribing USS, and so forth).

In various embodiments, an evolved packet system (“EPS”) capable of UAV services supports functionalities for: 1) subscription-based aerial UE identification and authorization, where a mobile management entity (“MME”) supporting the UAS services, retrieves the aerial UE subscription information from the home subscriber server (“HSS”) by using aerial-UE-subscription-information attribute value pair (“AVP”) from subscription-data AVP at the time of attach—the aerial subscription information is shared by an eNB by an aerial UE subscription information IE—the aerial subscription information may be passed on from one eNB to another eNB at the time of handover by using the aerial UE subscription information IE; 2) height reporting based on an event that the UE's altitude has crossed a network-configured reference altitude threshold; 3) interference detection based on a measurement reporting that is triggered if a configured number of cells (e.g., larger than one) fulfils the triggering criteria simultaneously; 4) signaling of flight path information from the UE to an evolved universal terrestrial radio access network (“E-UTRAN”); 5) location information reporting including a UE's horizontal and vertical velocity; and 6) open loop power control enhancements including UE specific pathloss compensation factor and an extended range of nominal target received power.

In certain embodiments, a UAV uses 3GPP access (e.g., LTE, new radio (“NR”)) for 3GPP UAV related operations. In some embodiments, a SMF plus PDN gateway (“PGW”) consumer (“C”) (“SMF+PGW-C”) implements various 3GPP functions such as: 1) triggering a UUAA session management (“SM”) (“UUAA-SM”) procedure for a UE requiring UAV authentication and authorization by a USS if requesting user plane resources for UAV operation, or if the USS and/or uncrewed aerial system traffic management (“UTM”) that authenticated the UAV triggers a re-authentication; and/or 2) triggering the authorization of pairing between a UAV and a networked UAV controller (“UAVC”) or a UAVC that connects to the UAV via internet connectivity during the establishment of the PDN connection and/or PDU session for C2 communication.

In some embodiments, an SMF+PGW-C has also access to HSS+UDM where it can access the UE's aerial subscription information from the HSS via the UDM.

In various embodiments, an AMF or SMF triggers an UUAA procedure if a UAV has an aerial UE subscription and the UAV requests access to UAS services by providing a civil aviation administration (“CAA”) level (“CAA-Level”) UAV ID of the UAV during a registration procedure or PDU session establishment procedure. Moreover, network support for UUAA during registration may be optional while it may be mandatory during PDU session establishment. UE support for UUAA during registration and during the PDU session establishment may be available.

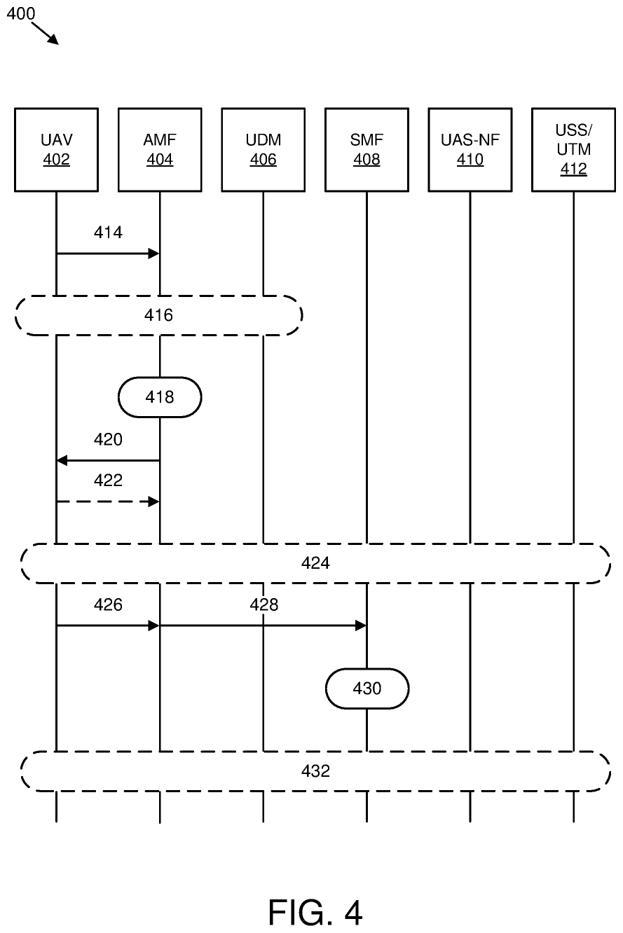

FIG. 4 is a schematic block diagram illustrating one embodiment of a system 400 for UUAA usage in a 5GS. The system 400 includes a UAV 402, an AMF 404, a UDM 406, an SMF 408, a UAS network function (“NF”) (“UAS-NF”) 410, and a USS and/or UTM (“USS/UTM”) 412. Each of the communications in the system 400 may include one or more messages.

In a first communication 414, a registration request may be sent from the UAV 402 to the AMF 404. In a second communication 416, primary authentication may be performed. Then, the AMF 404 may determine 418 whether UUAA is required for UAV. Moreover, in a third communication 420, a registration accept message may be sent. In a fourth communication 422, a registration complete message may be sent. Further, in a fifth communication 424, there may be UUAA at registration. Moreover, in a sixth communication 426 and a seventh communication 428, a PDU session establishment request may be sent from the UAV 402 to the SMF 408. The SMF 408 may determine 430 whether UUAA is required for UAV 402 (e.g., UE). The UUAA may only be triggered if the UAV 402 has provided a CAA-Level UAV ID and has a valid aerial UE subscription. The SMF 408 may skip UUAA if the UAV 402 has completed UUAA successfully with the same USS and/or DN before (e.g., in a previous PDU session establishment procedure or at registration).

In certain embodiments, an AMF may trigger a UUAA-MM procedure for a UE requiring UAV authentication and authorization by a USS if registering with a 5GS when the UE has aerial UE subscription information and based on local operator policy, if the USS that authenticated the UAV triggers a re-authentication, or if the AMF determines to re-authentication the UAV after the initial registration.

In some embodiments, the SMF may trigger a UUAA-SM procedure for a UE requiring UAV authentication and authorization by a USS if requesting user plane resources for UAV operation, or if the USS and/or UTM that authenticated the UAV triggers a re-authentication.

In various embodiments, a UAV that is provisioned with a CAA-Level UAV ID may provide the CAA-Level UAV ID in 5GS in both registration and in PDU session establishment. In certain embodiments, such as in evolved packet core (“EPC”), a UAV that is provisioned with a CAA-Level UAV ID provides the CAA-Level UAV ID in a PDN connection establishment in SM protocol configuration options (“PCO”) (“SM-PCO”). In some embodiments, a core network (“CN”) may determine whether UUAA is executed at 5GS registration or at PDU session and/or PDN connection establishment based on local policies.

In certain embodiments, if UUAA is not performed during a registration procedure in 5GS, the UUAA may be performed at PDU session establishment if the UAV requests user plane resources for UAV operation and the UAV provides its CAA level ID during PDU session (e.g., PDN connection) establishment.

In some embodiments, a CN may determine whether UUAA is executed at 5GS registration or at PDU session and/or PDN connection establishment based on local policies.

In various embodiments, if a UUAA has been performed at 5GS registration, there may be no need for the USS to perform UUAA at PDU session establishment.

In certain embodiments, if a UUAA is performed for a UE (e.g., UAV) at registration, then it may not be required to perform UUAA again during the subsequent PDU session establishment procedure. In some embodiments, based on a local policy, a CN may determine whether a UUAA is executed at 5G system (“5GS”) registration or at PDU session establishment. As registration happens an AMF may invoke UUAA and PDU session establishment which may involve an SMF that may invoke UUAA. Different UUAA invocation points, such as AMF and SMF without specific behavior or configurations to co-ordinate the UUAA requirement determination, may lead to repeated UUAA execution which may be redundant and unnecessary. In various embodiments, an AMF stores UUAA information, such as authorized CAA-level UAV ID, following a successful UUAA which is not shared with the SMF if a UUAA is skipped during the subsequent PDU session establishment leading to unavailability of UUAA results and information at the SMF during PDU session establishment.

In a first embodiment, a UUAA may be performed at the time of UE registration (e.g., UUAA-MM or PDU session establishment and/or modification).

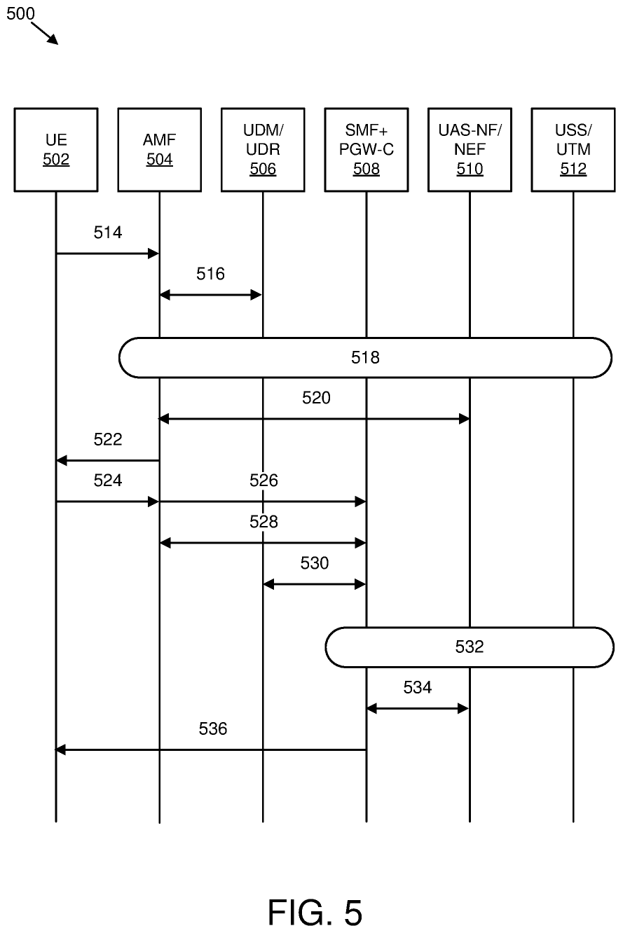

FIG. 5 is a schematic block diagram illustrating one embodiment of a system 500 for performing UUAA at a time of UE registration. The system 500 includes a UE 502, an AMF 504, a UDM/UDR 506, an SMF+PGW-C 508 (e.g., SMF 508), a UAS-NF and/or network exposure function (“NEF”) (“UAS-NF/NEF”) 510, and a USS/UTM 512. Each of the communications may include one or more messages.

In a first communication 514, the UE 502 constructs a REGISTRATION REQUEST message. If the UE 502 plans to initiate a UUAA-MM procedure, the REGISTRATION REQUEST message includes required parameters for UUAA-MM, such as CAA-level-UAV ID and UUAA aviation payload.

In a second communication 516, upon receipt of the REGISTRATION REQUEST message, the AMF 504 may retrieve the UE's subscription information even if the REGISTRATION REQUEST message is not initiating the UUAA-MM. The AMF 504 may get the UE's capability for the UAS services from the fifth generation (“5G”) mobility management (“MM”) (“5GMM”) capability information element inserted by the UE 502 in the REGISTRATION REQUEST message or by other means such as an identifier which is unique for the UE (e.g., PEI, international mobile equipment identifier (“IMEI”)).

In a third communication 518, if the REGISTRATION REQUEST is to initiate UUAA-MM, the AMF 504 passes the UE's related information for the UAS services to the UAS-NF/NEF 510 and/or USS/UTM 512 to perform the UUAA.

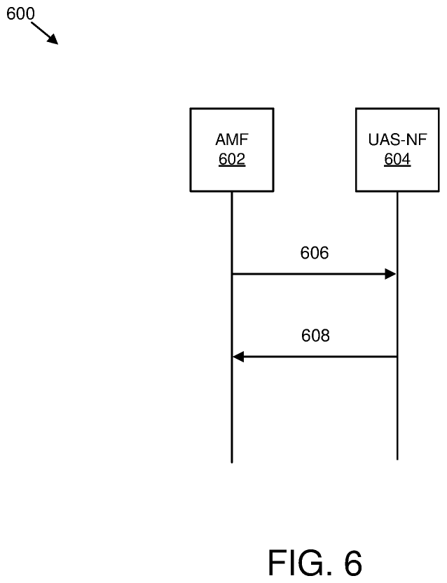

In a fourth communication 520, upon successful UUAA, the UAS-NF/NEF 510 stores the UE's UUAA status and the AMF 504 subscribes to the UE's UUAA status event with a transmission towards the UAS-NF/NEF 510 as shown in FIG. 6. Specifically, FIG. 6 is a schematic block diagram illustrating one embodiment of a system 600 for an AMF subscribing to a UE's UUAA status. The system 600 includes an AMF 602 and a UAS-NF 604. In a first communication 606, the AMF 602 may send a POST (e.g., (apiRoot)/nUas-nf-evts/<apiVersion>/subscriptions(UeUavUuaaStatusEventSubscription)) with a request to create a subscription resource in the AMF 602 for the UE's UUAA status which may be successful or unsuccessful. In a second communication 608, the UAS-NF 604 may include a HTTP Location header to provide the location of a newly created resource (e.g., subscription) together with the status code 201 (e.g., 201 created (UeUavUuaaStatusEventSubscription) message) indicating the requested resource is created in the response message.

Returning to FIG. 5, in a fifth communication 522, to establish and/or modify a PDU session with the purpose for the UAS related service, the UE 502 may construct a PDU SESSION ESTABLISHMENT and/or MODIFICATION REQUEST message comprising required parameters for the UAS service, such as a CAA level UAV ID, a USS server address, a UUAA aviation payload, and/or any needed information.

In certain embodiments, the PDU SESSION ESTABLISHMENT and/or MODIFICATION REQUEST message may be transmitted as a part of a payload container information element (“IE”) of the UL non-access stratum (“NAS”) TRANSPORT message with the payload container type set to the value of N1 SM information. The UE payload container IE may include an optional IE set to a value of the service level authorization and authentication (“AA”) (“service-level-AA”) container information, where the purpose of the service-level-AA container information IE may be to convey the UAS services related information for the PDU session. It should be noted that a purpose for the UL NAS TRANSPORT message may not be for the UUAA, but for any request related to the UAS service. Further, the service-level-AA container information IE may be coded as shown in Table 1 and Table 1. Moreover, the service-level-AA container information IE may be type 1 information element.

TABLE 1
Service-level-AA container information IE

| 8 | 7 | 6 | 5 | 4 | 3 | 2 | 1 | |
|---|---|---|---|---|---|---|---|---|
| Z | Z | Z | Z | Z | Z | Z | Z | Z |

| | | |
|---|---|---|
| Service-level-AA | Service-level-AA | octet 1 |
| container | container | |
| information IE | information value | |

TABLE 2
Service-level-AA container information IE
Service-level-AA container information value (octet 1, bit 1 to bit 4)
Bits

| 4 | 3 | 2 | 1 | |
|---|---|---|---|---|
| 0 | 0 | 0 | 0 | No additional information |
| 0 | 0 | 0 | 1 | UUAA request |
| 0 | 0 | 1 | 0 | UAS service related session |

All other values are spare.

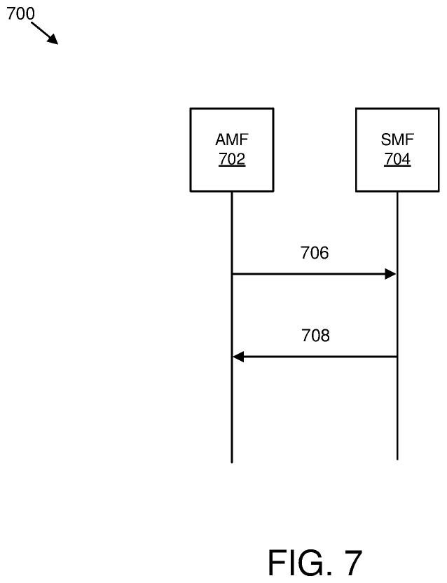

In a sixth communication 524 and a seventh communication 526, upon receipt of the UL NAS TRANSPORT message, the AMF 504 may check the optional IE within the payload container IE to find out if it is set to the service-level-AA container information with the value of a UAS service related request. In some embodiments, the AMF 504 may check the data network name (“DNN”) and/or single (“S”) network slice selection assistance information (“NSSAI”) (“S-NSSAI”) and realize that the contents is for the UAS service. If the AMF 504 has already performed the UUAA-MM, independent of the SMF has subscribed to the UE's UUAA status, the AMF 504 may notify the SMF about the status of the UE's UUAA as shown in FIG. 7. Specifically, FIG. 7 is a schematic block diagram illustrating one embodiment of a system 700 for an AMF 702 informing an SMF 704 about the UE's UUAA status. In a first communication 706, the AMF 720 transmits a POST (e.g., UeUavUuaaStatusUri, UeUavUuaaStatusNotification) to the SMF 704. In a second communication 708, the SMF 704 transmits a 204 no content message to the AMF 702.

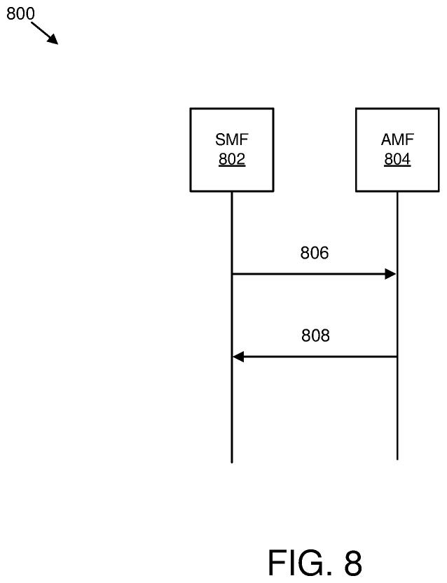

Returning to FIG. 5, in an eighth communication 528, upon receipt of the PDU session establishment and/or modification request, the SMF may check to find out if the UE's UUAA result information is locally available. If this information is not available, the SMF may invoke a subscription towards the AMF 504, to the UE's UUAA status event as shown in FIG. 8.

Specifically, FIG. 8 is a schematic block diagram illustrating one embodiment of a system 800 for an SMF 802 subscribing to the UE's UUAA status with a transmission towards an AMF 804. In a first communication 806, the AMF 804 may send an HTTP method POST with resource uniform resource indicator (“URI”) comprising the application programming interface (“API”) root and API version and dedicated for an AMF event. As an example, the resource URI may include {apiRoot}/namf-evts/<apiVersion>/subscriptions. Moreover, the body of the HTTP POST message may include: 1) an identity of the SMF; 2) a subscription target which is the UE which may be identified (e.g., by subscription permanent identifier (“SUPI”), permanent equipment identifier (“PEI”), global public subscription identifier (“GPSI”) or CAA-level-UAV ID); 3) an event for the UE's UUAA status and its event type; and/or 4) an immediate report flag per event with the value set to “true”, indicating an immediate report to be generated with current event status. The SMF 802 (e.g., SMF+PGW-C 508) sends the constructed POST request to the AMF 804 to create a subscription resource in the AMF 804 for the UE's UUAA status which may be successful or unsuccessful. In a second communication 808, upon acceptance from the AMF 804, the AMF 804 may include a hypertext transfer protocol (“HTTP”) location header to provide the location of a newly created resource (e.g., subscription) together with the status code 201 indicating the requested resource is created in the response message. Since the immediate report flag with value as “true” in the event subscription, the AMF 804 includes the current status report of the UE's UUAA in the 201 created and the SMF 802 may store the UE's UUAA status.

Returning to FIG. 5, in a ninth communication 530, if the SMF 508 does not get any information about the UE's UUAA, the SMF 508 may retrieve the UE's aerial subscription information from the UDM/UDR 506.

In a tenth communication 532, if the UE's aerial subscription information is allowed, the SMF 508 may initiate UUAA-SM by passing the UE's related information for the UAS services to the UAS-NF/NEF 510 and/or USS/UTM 512 to perform the UUAA.

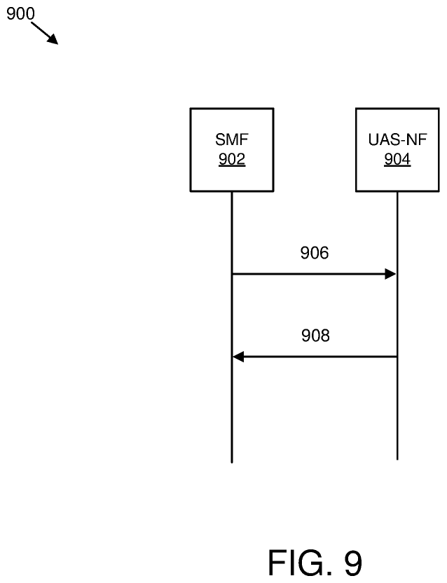

In an eleventh communication 534, upon successful UUAA, the UAS-NF/NEF 510 stores the UE's UUAA status and the SMF 508 may subscribe to the UE's UUAA status event with a transmission towards the UAS-NF/NEF 510 as shown in FIG. 9.

Specifically, FIG. 9 is a schematic block diagram illustrating one embodiment of a system 900 for an SMF 902 subscribing to the UE's UUAA status with a transmission to a UAS-NF 904. In a first communication 906, the SMF 902 may send a POST request to create a subscription resource in the SMF 902 for the UE's UUAA status which may be successful or unsuccessful. In a second communication 908, the UAS-NF 904 may include a HTTP location header to provide the location of a newly created resource (e.g., subscription) together with the status code 201 indicating the requested resource is created in the response message. It should be noted that the communications of FIG. 9 may be performed (e.g., the SMF 902 subscribes to the UE's UUAA status) even if the SMF 902 receives the UE's UUAA status.

Returning to FIG. 5, in a twelfth communication 536, the SMF 508 sends a PDU session response towards the UE 502.

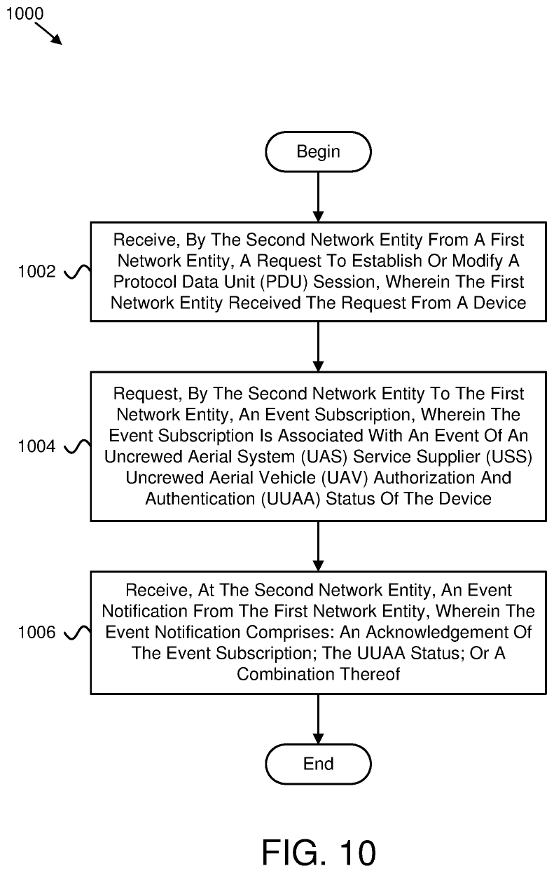

FIG. 10 is a flow chart diagram illustrating one embodiment of a method 1000 for uncrewed aerial system service supplier uncrewed aerial vehicle authorization and authentication event subscription. In some embodiments, the method 1000 is performed by an apparatus, such as the network unit 104. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes receiving 1002, by a second network entity from a first network entity, a request to establish or modify a protocol data unit (PDU) session. The first network entity received the request from a device. In some embodiments, the method 1000 includes requesting 1004, by the second network entity to the first network entity, an event subscription. The event subscription is associated with an event of an uncrewed aerial system (UAS) service supplier (USS) uncrewed aerial vehicle (UAV) authorization and authentication (UUAA) status of the device. In certain embodiments, the method 1000 includes receiving 1006, at the second network entity, an event notification from the first network entity. The event notification includes: an acknowledgement of the event subscription; the UUAA status; or a combination thereof.

In certain embodiments, the first network entity comprises an access and mobility management function (AMF). In some embodiments, the second network entity comprises a session and mobility management function (SMF).

In various embodiments, the device comprises a user equipment (UE). In one embodiment, the method 1000 further comprises receiving, at the second network entity, a notification of a status change from the first network entity in response to the second network entity being subscribed to the first network entity.

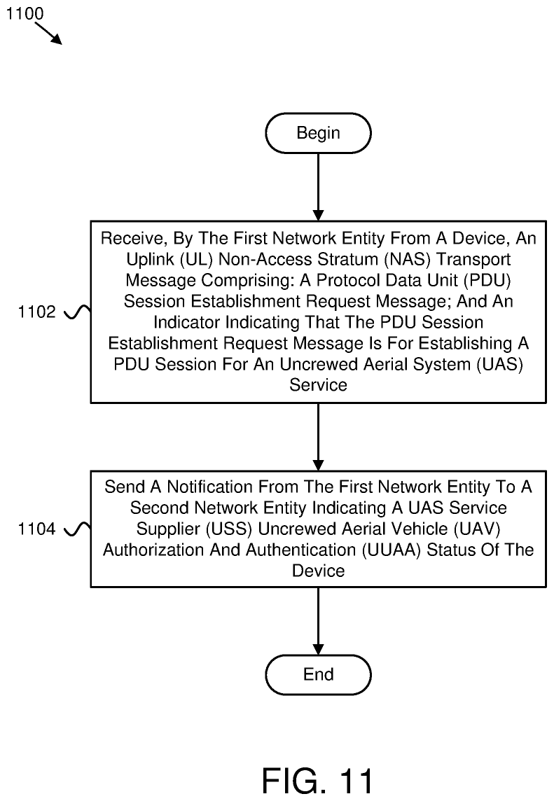

FIG. 11 is a flow chart diagram illustrating another embodiment of a method 1100 for uncrewed aerial system service supplier uncrewed aerial vehicle authorization and authentication event subscription. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes receiving 1102, by a first network entity from a device, an uplink (UL) non-access stratum (NAS) transport message including: a protocol data unit (PDU) session establishment request message; and an indicator indicating that the PDU session establishment request message is for establishing a PDU session for an uncrewed aerial system (UAS) service. In some embodiments, the method 1100 includes sending 1104 a notification from the first network entity to a second network entity indicating a UAS service supplier (USS) uncrewed aerial vehicle (UAV) authorization and authentication (UUAA) status of the device.

In certain embodiments, the UL NAS transport message comprises: a payload container information element comprising: the PDU session establishment request message to establish a PDU session, wherein the PDU session establishment request message comprises a first information element (IE) comprising a civil aviation administration (CAA) level (CAA-level) UAV identifier (ID) and: a USS address; a UUAA aviation payload; or a combination thereof; and a second IE set to a value of service-level-AA container information, wherein the value of the service-level-AA container information indicates the PDU session if for a UAS service. In some embodiments, the first network entity comprises an access and mobility management function (AMF).

In various embodiments, the second network entity comprises a session and mobility management function (SMF). In one embodiment, the device comprises a user equipment (UE). In certain embodiments, the method 1100 further comprises transmitting, from the first network entity, a notification of a status change to the second network entity in response to the second network entity being subscribed to the first network entity.

In one embodiment, an apparatus comprises a second network entity. The apparatus further comprises: a receiver that receives, by the second network entity from a first network entity, a request to establish or modify a protocol data unit (PDU) session, wherein the first network entity received the request from a device; and a transmitter that requests, by the second network entity to the first network entity, an event subscription, wherein the event subscription is associated with an event of an uncrewed aerial system (UAS) service supplier (USS) uncrewed aerial vehicle (UAV) authorization and authentication (UUAA) status of the device, wherein the receiver receives, at the second network entity, an event notification from the first network entity, and the event notification comprises: an acknowledgement of the event subscription; the UUAA status; or a combination thereof.

In certain embodiments, the first network entity comprises an access and mobility management function (AMF).

In some embodiments, the second network entity comprises a session and mobility management function (SMF).

In various embodiments, the device comprises a user equipment (UE).

In one embodiment, the receiver receives, at the second network entity, a notification of a status change from the first network entity in response to the second network entity being subscribed to the first network entity.

In one embodiment, a method of a second network entity comprises: receiving, by the second network entity from a first network entity, a request to establish or modify a protocol data unit (PDU) session, wherein the first network entity received the request from a device; requesting, by the second network entity to the first network entity, an event subscription, wherein the event subscription is associated with an event of an uncrewed aerial system (UAS) service supplier (USS) uncrewed aerial vehicle (UAV) authorization and authentication (UUAA) status of the device; and receiving, at the second network entity, an event notification from the first network entity, wherein the event notification comprises: an acknowledgement of the event subscription; the UUAA status; or a combination thereof.

In certain embodiments, the first network entity comprises an access and mobility management function (AMF).

In some embodiments, the second network entity comprises a session and mobility management function (SMF).

In various embodiments, the device comprises a user equipment (UE).

In one embodiment, the method further comprises receiving, at the second network entity, a notification of a status change from the first network entity in response to the second network entity being subscribed to the first network entity.

In one embodiment, an apparatus comprises a first network entity. The apparatus further comprises: a receiver that receives, by the first network entity from a device, an uplink (UL) non-access stratum (NAS) transport message comprising: a protocol data unit (PDU) session establishment request message; and an indicator indicating that the PDU session establishment request message is for establishing a PDU session for an uncrewed aerial system (UAS) service; and a transmitter that sends a notification from the first network entity to a second network entity indicating a UAS service supplier (USS) uncrewed aerial vehicle (UAV) authorization and authentication (UUAA) status of the device.

In certain embodiments, the UL NAS transport message comprises: a payload container information element comprising: the PDU session establishment request message to establish a PDU session, wherein the PDU session establishment request message comprises a first information element (IE) comprising a civil aviation administration (CAA) level (CAA-level) UAV identifier (ID) and: a USS address; a UUAA aviation payload; or a combination thereof; and a second IE set to a value of service-level-AA container information, wherein the value of the service-level-AA container information indicates the PDU session if for a UAS service.

In some embodiments, the first network entity comprises an access and mobility management function (AMF).

In various embodiments, the second network entity comprises a session and mobility management function (SMF).

In one embodiment, the device comprises a user equipment (UE).

In certain embodiments, the transmitter transmits, from the first network entity, a notification of a status change to the second network entity in response to the second network entity being subscribed to the first network entity.

In one embodiment, a method of a first network entity comprises: receiving, by the first network entity from a device, an uplink (UL) non-access stratum (NAS) transport message comprising: a protocol data unit (PDU) session establishment request message; and an indicator indicating that the PDU session establishment request message is for establishing a PDU session for an uncrewed aerial system (UAS) service; and sending a notification from the first network entity to a second network entity indicating a UAS service supplier (USS) uncrewed aerial vehicle (UAV) authorization and authentication (UUAA) status of the device.

In certain embodiments, the UL NAS transport message comprises: a payload container information element comprising: the PDU session establishment request message to establish a PDU session, wherein the PDU session establishment request message comprises a first information element (IE) comprising a civil aviation administration (CAA) level (CAA-level) UAV identifier (ID) and: a USS address; a UUAA aviation payload; or a combination thereof; and a second IE set to a value of service-level-AA container information, wherein the value of the service-level-AA container information indicates the PDU session if for a UAS service.

In some embodiments, the first network entity comprises an access and mobility management function (AMF).

In various embodiments, the second network entity comprises a session and mobility management function (SMF).

In one embodiment, the device comprises a user equipment (UE).

In certain embodiments, the method further comprises transmitting, from the first network entity, a notification of a status change to the second network entity in response to the second network entity being subscribed to the first network entity.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function of a second network entity, the apparatus comprising:
at least one memory; and
at least one processor coupled with the at least one memory and configured to cause the apparatus to:
receive, by the second network entity from a first network entity, a request to establish or modify a protocol data unit (PDU) session, wherein the first network entity received the request from a device; and
request, by the second network entity to the first network entity, an event subscription, wherein the event subscription is associated with an event of an uncrewed aerial system (UAS) service supplier (USS) uncrewed aerial vehicle (UAV) authorization and authentication (UUAA) status of the device, wherein the receiver receives, at the second network entity, an event notification from the first network entity, and the event notification comprises:
an acknowledgement of the event subscription;
the UUAA status;
or a combination thereof.

2. The apparatus of claim 1, wherein the first network entity comprises an access and mobility management function (AMF).

3. The apparatus of claim 1, wherein the second network entity comprises a session and mobility management function (SMF).

4. The apparatus of claim 1, wherein the device comprises a user equipment (UE).

5. The apparatus of claim 1, wherein the at least one processor is configured to cause the apparatus to receive, at the second network entity, a notification of a status change from the first network entity in response to the second network entity being subscribed to the first network entity.

6. A method of performing a network function at a second network entity, the method comprising:
receiving, by the second network entity from a first network entity, a request to establish or modify a protocol data unit (PDU) session, wherein the first network entity received the request from a device;
requesting, by the second network entity to the first network entity, an event subscription, wherein the event subscription is associated with an event of an uncrewed aerial system (UAS) service supplier (USS) uncrewed aerial vehicle (UAV) authorization and authentication (UUAA) status of the device; and
receiving, at the second network entity, an event notification from the first network entity, wherein the event notification comprises:
an acknowledgement of the event subscription;
the UUAA status;
or a combination thereof.

7. The method of claim 6, wherein the first network entity comprises an access and mobility management function (AMF) and the second network entity comprises a session and mobility management function (SMF).

8. The method of claim 6, wherein the device comprises a user equipment (UE).

9. The method of claim 6, further comprising receiving, at the second network entity, a notification of a status change from the first network entity in response to the second network entity being subscribed to the first network entity.

10. An apparatus for performing a network function of a first network entity, the apparatus comprising:
at least one memory; and
at least one processor coupled with the at least one memory and configured to cause the apparatus to:
receive, by the first network entity from a device, an uplink (UL) non-access stratum (NAS) transport message comprising:
a protocol data unit (PDU) session establishment request message; and
an indicator indicating that the PDU session establishment request message is for establishing a PDU session for an uncrewed aerial system (UAS) service; and
send a notification from the first network entity to a second network entity indicating a UAS service supplier (USS) uncrewed aerial vehicle (UAV) authorization and authentication (UUAA) status of the device.

11. The apparatus of claim 10, wherein the UL NAS transport message comprises:
a payload container information element comprising:
the PDU session establishment request message to establish a PDU session, wherein the PDU session establishment request message comprises a first information element (IE) comprising a civil aviation administration (CAA) level (CAA-level) UAV identifier (ID) and:
a USS address;
a UUAA aviation payload;
or a combination thereof; and
a second IE set to a value of service-level-AA container information, wherein the value of the service-level-AA container information indicates the PDU session if for a UAS service.

12. The apparatus of claim 10, wherein the first network entity comprises an access and mobility management function (AMF).

13. The apparatus of claim 10, wherein the second network entity comprises a session and mobility management function (SMF).

14. The apparatus of claim 10, wherein the device comprises a user equipment (UE).

15. The apparatus of claim 10 any of claims 10 to 14, wherein the at least one processor is configured to cause the apparatus to transmit, from the first network entity, a notification of a status change to the second network entity in response to the second network entity being subscribed to the first network entity.

16. A method of performing a network function at a first network entity, the method comprising:
receiving, by the first network entity from a device, an uplink (UL) non-access stratum (NAS) transport message comprising:
a protocol data unit (PDU) session establishment request message; and
an indicator indicating that the PDU session establishment request message is for establishing a PDU session for an uncrewed aerial system (UAS) service; and
sending a notification from the first network entity to a second network entity indicating a UAS service supplier (USS) uncrewed aerial vehicle (UAV) authorization and authentication (UUAA) status of the device.

17. The method of claim 16, wherein the UL NAS transport message comprises:
a payload container information element comprising:
the PDU session establishment request message to establish a PDU session, wherein the PDU session establishment request message comprises
a first information element (IE) comprising a civil aviation administration (CAA) level (CAA-level) UAV identifier (ID) and:
a USS address;
a UUAA aviation payload;
or a combination thereof; and
a second IE set to a value of service-level-AA container information, wherein the value of the service-level-AA container information indicates the PDU session if for a UAS service.

18. The method of claim 16, wherein the first network entity comprises an access and mobility management function (AMF).

19. The method of claim 16, wherein the second network entity comprises a session and mobility management function (SMF).

20. The method of claim 16, further comprising transmitting, from the first network entity, a notification of a status change to the second network entity in response to the second network entity being subscribed to the first network entity.
